(19) United States
(12) Patent Application Publication
(10) Pub. No.: US 2010/0285423 A1
(43) Pub. Date: Nov. 11, 2010

(54) Dental Hand-Held Instrument for Generating Measurement Results

(75) Inventor: Hans Heckenberger, Assmannshardt (DE)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: KALTENBACH & VOIGT GMBH, Biberach (DE)

(21) Appl. No.: 12/671,472

(22) PCT Filed: Jul. 28, 2008
(86) PCT No.: PCT/EP2008/006196

§ 371 Date: Feb. 3, 2010

(30) Foreign Application Priority Data
Aug. 1, 2007 (DE) 10 2007 036 096.9

(51) Int. Cl. A61C 19/06

(52) U.S. Cl. 433/29

(57) ABSTRACT

A dental diagnostic system comprising a hand-held instrument that is equipped with means for detecting measured values and a transmission unit which is integrated into the housing and is used for wireless transmission of said measured values by means of infrared signals, and an external display and/or evaluation unit. The transmission unit of the hand-held instrument is designed in such a way that the infrared signals are emitted in at least two different directions.

The present invention relates to a hand-held dental instrument in accordance with the preamble of claim 1 which in addition to having means for picking up measured values has a transmission unit that is arranged in the housing of the hand-held instrument for transmitting the measurement results to an external display and/or evaluation unit by means of infrared signals.

A great variety of hand-held instruments are known in dental diagnostics that are provided with a visual indicator that indicates the measured values that are determined by the hand-held instrument. These measured values can be determined, for example, by irradiating the tooth tissue with monochromatic radiation, and the radiation that is reflected back or the fluorescent radiation is measured. The determination of the measured values can also be carried out in a different way, such as, for instance, by applying a voltage to two points on the surface of a tooth.

The measurement data thus picked up are fed to an acquisition and evaluation element which can be integrated in the hand-held instrument. This element converts the measurement data into a digital signal which is displayed on the visual indicator of the hand-held instrument.

Hand-held instruments of this kind, which are suitable for visually identifying caries, tartar or the like, are described, for example, in DE 10 2004 024 165 A1. In the case of this known measuring instrument, the measured values are determined by irradiating the tooth tissue with monochromatic radiation and measuring the response radiation. The light source and also acquisition and evaluation means for acquiring and evaluating the response radiation are integrated into the hand-held instrument. The measurement result is displayed on a display on the hand-held instrument. The evaluation and indication of the result can also take place by means of a console to which the hand-held instrument can be connected either by way of a flexible connection or in a wireless manner.

The hand-held instrument described in the prior art allows the dentist performing the treatment to read off the measurement result on the display integrated into the hand-held instrument or on an external console. Many patients also want to be able to read off the measured value themselves. It is not, however, possible for them to look into a display that is integrated into the hand-held instrument, and an indicator on a display that is fitted on the treatment unit on account of the rigid securement is also not favorable, since it is not possible to look into it in every position during the examination of the patient.

The underlying set object of the present invention is therefore to equip the hand-held instrument with an infrared transmitter that enables the hand-held instrument to communicate with an indicator element which is not rigidly secured, but which can be arranged selectively in a position that is favorable for the patient. The hand-piece is then to be configured in a way that guarantees a transfer that is as free of interruptions as possible.

The object set is achieved by means of the invention that is defined in claim 1. Advantageous further developments of the invention constitute subject-matter of the dependent claims.

In this connection, in accordance with the present invention it is proposed that the infrared transmitter that is integrated into the hand-held instrument be configured in such a way that the infrared radiation is emitted into, as far as possible, a spatial range. The hand-held instrument in accordance with the invention accordingly contains means for generating measurement results and also a transmission unit that emits the infrared signal in at least two directions in space.

The infrared radiation is preferably produced by a transmission unit that is located at the rear end of the hand-held instrument and which has one or more infrared diodes that emit the radiation at various angles. In order to increase the emission angle of the infrared diodes, a dispersion lens can be fitted in front of the diode. The dispersion lens is preferably formed by the housing cover. This has the advantage that the instrument is easier to clean and sterilize. Developments are also possible in which a dispersion cone or a dispersion sphere is located in front of the diode. The infrared radiation that is emitted is distributed into a greater spatial angle by means of the dispersion sphere or the dispersion cone respectively. Alternatively, the light of an individual infrared diode can also be coupled into a light-guiding system which is split up into a plurality of individual light-guiding fibers that emit in various directions in space.

An advantageous further development of the invention consists in the fact that the hand-held instrument in accordance with claim 1 is part of a dental diagnostic system which comprises the hand-held instrument and an external display and/or evaluation unit. This external display and/or evaluation unit is preferably configured in such a way that it forms a place of deposit for the hand-held instrument. The place of deposit of the hand-held instrument can, furthermore, be provided with means that identify whether the hand-held instrument has been removed from the place of deposit and automatically switch the external display and/or evaluation unit on and off in a corresponding manner. The means just mentioned are, for example, a reed contact. The external display unit can, furthermore, preferably be held by the patient in his hand and thus be tracked independently during the examination.

The external display and/or evaluation unit can, furthermore, be equipped with a plurality of infrared receivers which have various angles of view into the space. In this way, it is guaranteed that always at least one transmitter can receive the infrared signal of the hand-held instrument.

A lens is preferably arranged in front of the infrared receiver that enables as much infrared radiation as possible to be acquired. The lens can, for example, also be integrated into the injection-molded housing of the receiver. In order to prevent IR-radiation from the surroundings—originating, for example, from fluorescent tubes—from falling onto the receiver and accordingly impairing the data-transfer, the lens can be formed as a cylinder lens. As an alternative to this, it would be possible to provide the receiver with a slotted diaphragm which has the same function. The individual infrared receivers can be connected selectively by way of a Dil switch (dual-inline switch).

The external display and/or evaluation unit is preferably equipped with software that determines the quality of the infrared signal that is received and has a process for error-checking. Examples of such processes are the cyclic redundancy check or the check-sum process. The signal quality that is determined by the software is preferably displayed graphically on the screen. This allows the user to identify whether disturbing outside influences are hindering the signal-transfer and to take corresponding counter-measures, if applicable.

The invention is explained in greater detail in the following with the aid of the enclosed drawing, in which:

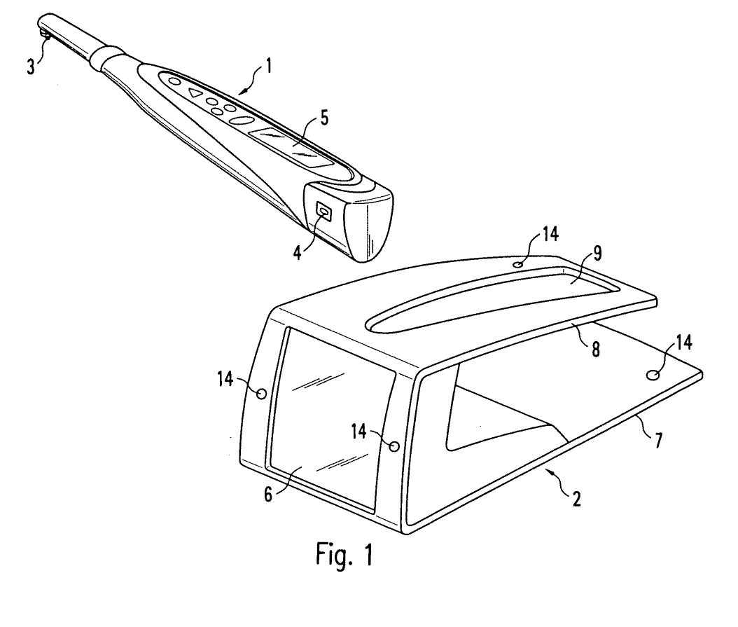

FIG. 1 shows a dental diagnostic system in accordance with the invention, consisting of a hand-held instrument and an external display and/or evaluation unit;

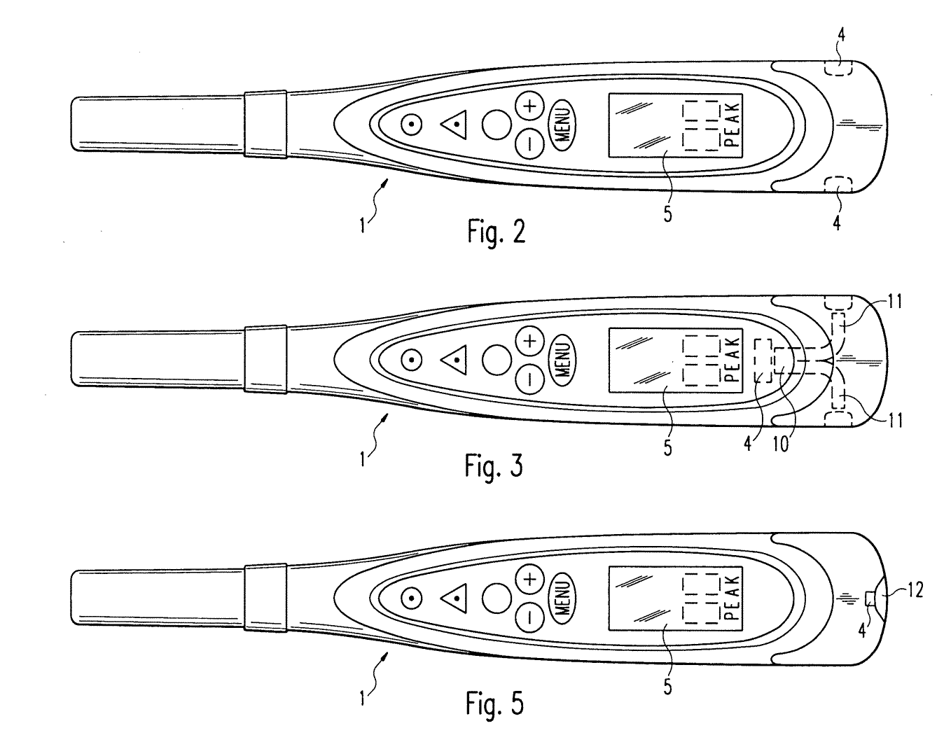

FIG. 2 shows a development of the hand-held instrument with two infrared diodes;

FIG. 3 shows a second variant of the hand-held instrument:

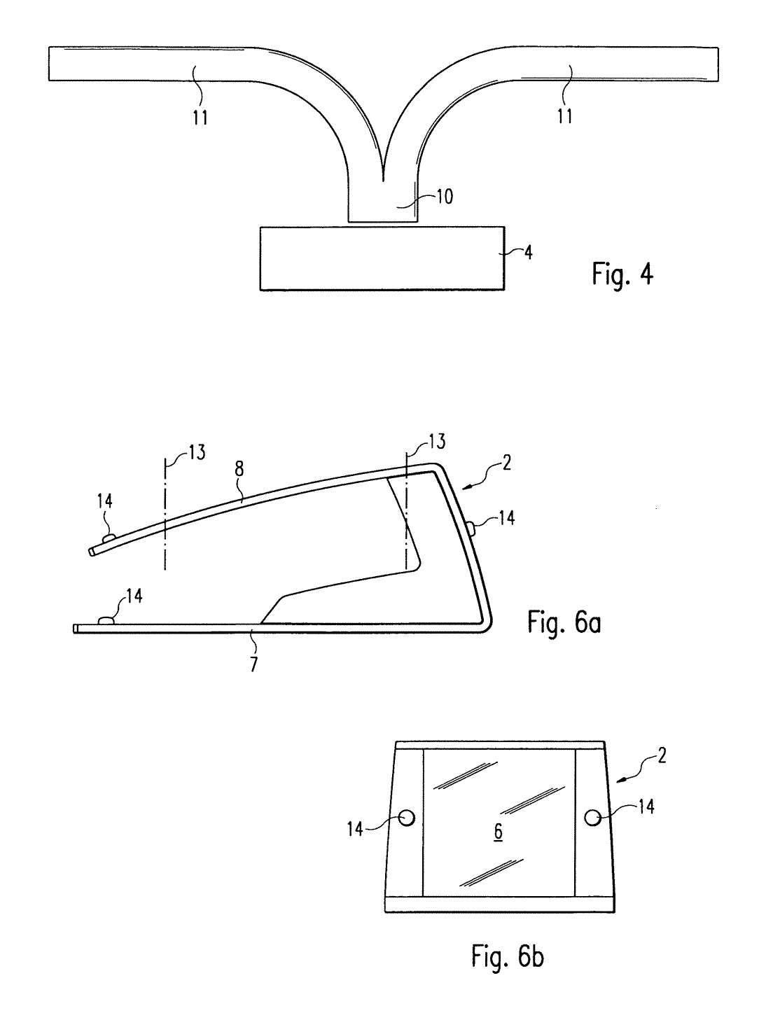

FIG. 4 shows a possible development of a light-guiding system which is split up into a plurality of light-guiding fibers;

FIG. 5 shows a third variant of the hand-held instrument;

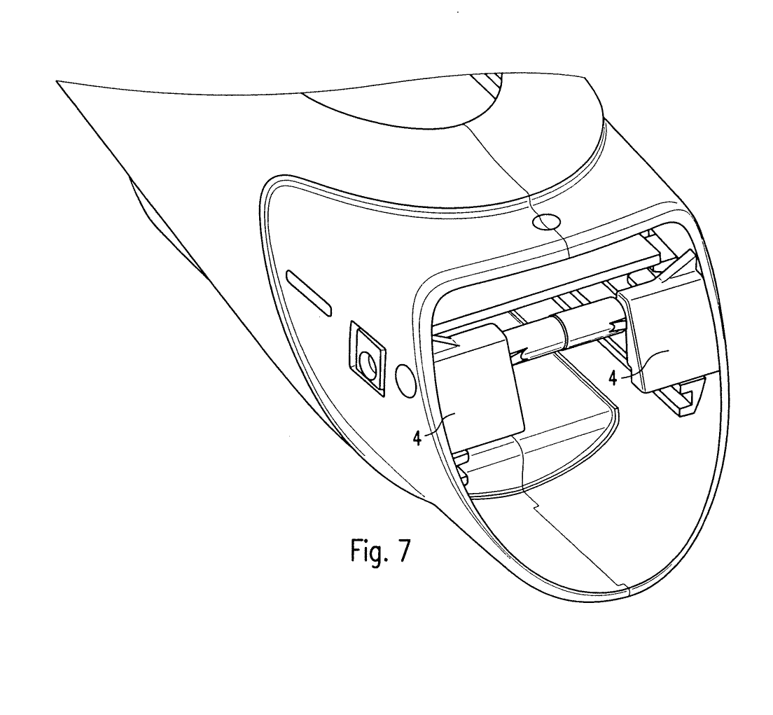

FIG. 6a shows a side view of the external display and/or evaluation unit;

FIG. 6b shows a front view of the external display and/or evaluation unit;

FIG. 7 shows the rear end of the hand-held instrument in its first embodiment without the housing cover;

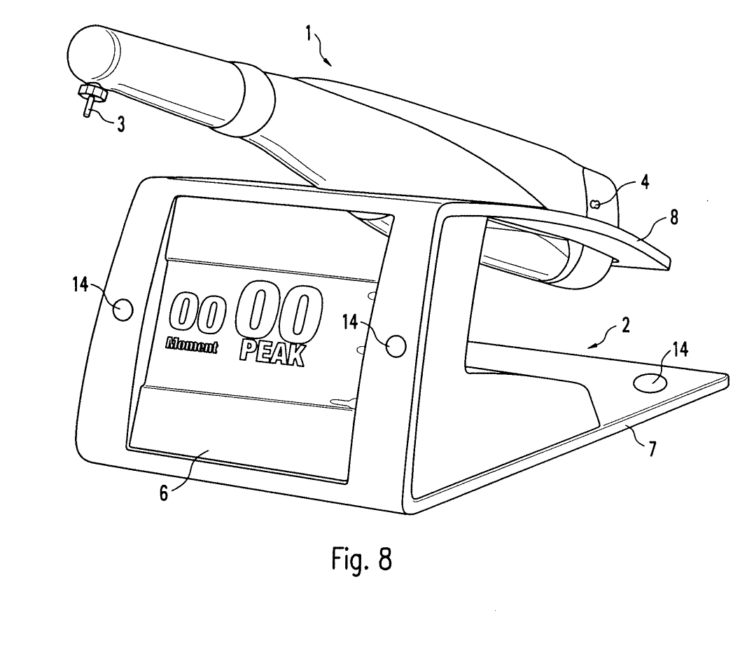

FIG. 8 shows a perspective representation of the first embodiment of the hand-held instrument in the deposit place of the external display and/or evaluation unit.

FIG. 1 shows a perspective representation of a first embodiment of a dental diagnostic system which is formed by a hand-held instrument 1 in accordance with the invention and an external display and/or evaluation unit 2. The hand-held instrument 1 is configured in this connection in such a way that located in its front region there are measuring instruments 3 with which measured values are picked up and in its rear region there is a transmission unit which renders possible wireless transmission of the measurement results to the external display and/or evaluation unit 2.

In the case of the embodiment shown in FIG. 1, the visual properties of the tooth tissue are examined, in particular in order to identify caries, plaque, bacterial invasion, concretions and tartar, by irradiation of the tooth tissue with stimulating radiation and measurement of the response radiation. An evaluation unit that is integrated into the hand-held instrument can determine, with the aid of the spectrum of the response radiation, whether one of the above-mentioned substances is present or not. A detailed description of this hand-held instrument can be found in DE 10 2004 024 165 A1. Express reference is to be made here to the fact that various methods for generating the measured values are possible for the hand-held instrument in accordance with the invention, and there is no restriction to visual measuring methods.

In the present embodiment the transmission unit has two infrared diodes 4 which are fitted oppositely. These diodes emit an infrared signal that transfers the measurement data determined by the evaluation unit to the external display and/or evaluation unit. Furthermore, the hand-held instrument has a display 5 which indicates the measurement results to the doctor performing the treatment.

The second part of the diagnostic system is formed by an external display and/or evaluation unit 2 which has a screen 6 and also a lower cover 7 and an upper cover 8. Formed in the upper cover 8 there is a recess 9 which enables the hand-held instrument 1 to be deposited. This place of deposit 9 is preferably equipped with means that identify whether the hand-held instrument has been removed from the place of deposit and switch the external display and/or evaluation unit 2 on and off in a corresponding manner. This is, for example, a reed contact. Other means for identifying the removal, such as, for instance, light barriers, can, however, also be used.

The external display and/or evaluation unit 2 is configured in such a way that the patient can hold it in his hand during the examination. As a result, it is made possible for the patient to position the external display and/or evaluation unit 2 always in such a way that he can read off the screen 6. The external display and/or evaluation unit can be equipped with a plurality of infrared receivers 14 which have various angles of view into the room or space. In FIG. 1, for example, in each case one of these receivers 14 is arranged on the left and the right next to the screen 6 and also on the upper cover 8 and the lower cover 7. In this way, it is guaranteed that always at least one transmitter can receive the infrared signal of the hand-held instrument. Arranged in front of the infrared receiver there is preferably a lens which makes it possible to acquire as much infrared radiation as possible. The lens can, for example, also be integrated into the injection-molded housing of the receiver.

FIG. 2 shows the first embodiment of the hand-held instrument 1 viewed from above. The two infrared diodes 4 are fitted lying opposite each other so that they emit the infrared signal in opposite directions in space. The infrared diodes 4 are arranged inside the instrument housing. Since the hand-held instrument in accordance with the invention is used in a dental practice, it must be easy to clean and disinfect. This requirement is met in that the diodes are located inside the housing cover. At the same time, the housing cover must be configured in such a way that it does not absorb the infrared radiation emitted by the diodes.

Developments of the hand-held instrument 1 are also possible in which the infrared signal is emitted from more than two infrared diodes. The use of additional diodes, for example three diodes, would then bring about the advantage that the emitting characteristics can be adapted in the best possible way to those of a spherical radiator.

FIG. 7 likewise shows a development with two infrared diodes 4 that lie opposite each other. In FIG. 7, the housing cover is not drawn in completely, so that the interior of the hand-held instrument 1 becomes visible. The set-up of the two diodes 4 has mirror symmetry.

In FIG. 8, this embodiment is shown again. Here, the hand-held instrument 1 lies in the deposit place of the external display and/or evaluation unit 2.

A second development of the hand-held instrument 1 in accordance with the invention can be inferred from FIG. 3. Here, the transmission unit has a single infrared diode 4 which is coupled to a light guide 10. This light guide 10 is split up into two light-guiding fibers 11 which extend further in opposition to each other. The two light-guiding fibers 11 each end at a point on the instrument housing from which the infrared radiation emerges. Owing to the fact that the two light-guiding fibers 11 are guided to opposite points, the infrared radiation is emitted in two opposite directions in space. As a result of this development, the source size of the emitter chip is virtually increased. This is advantageous, since as a result a different, low, laser classification can ensue. Developments of the light-guiding system are also possible in which the light guide 10 is divided up into more than two fibers so that the infrared signal is emitted from more than two points on the instrument housing.

The light-guiding system is diagrammatically represented in FIG. 4.

FIG. 5 shows a third development of the hand-held instrument 1 in accordance with the invention. In this development, the transmission system likewise has a single infrared diode 4. This is arranged in front of the rear wall of the instrument housing. Located in front of the diode 4 there is a dispersion lens 12 which is formed by the instrument housing. The dispersion lens 12 ensures that the infrared radiation that is emitted by the diode 4 is emitted with a large emission angle. It is also possible to position a dispersion cone or a dispersion sphere in front of the diode 4 and thus maximize the emission angle. As a result of using a dispersion cone or a dispersion sphere, the chip face can be covered, this being advantageous on account of improved infrared security.

A side view of the external display and/or evaluation unit 2 can be inferred from FIG. 6a. The dot-dash lines 13 are used to indicate at what point the hand-held instrument 1 is located when laid in the place of deposit 9.

FIG. 6b shows the external display and/or evaluation unit 2 in the view from the front. This external display and/or evaluation unit 2 can be equipped with software which determines the quality of the infrared signal that is received and thus establishes whether a valid infrared signal is present. The software should be able to carry out an error-check; possible methods for error-checking are, for example, the cyclic redundancy check (CRC) or a check-sum process. Furthermore, the software can determine how many infrared data packets the external display and/or evaluation unit 2 receives per unit of time and calculate therefrom the quality of the signal that is received. The signal quality can be displayed graphically on the screen for the user. As a result, it is possible for the user to identify whether there are disturbing outside influences, and, if applicable, he can take corresponding counter-measures.

1. A hand-held dental instrument having means to generate measurement results and also a transmission unit that is arranged in a housing of the hand-held instrument to transmit the measurement results to an external display and/or evaluation unit by infrared signals, wherein
the transmission unit is configured such that the infrared signals are emitted in at least two directions in space.

2. A hand-held instrument according to claim 1, wherein
the transmission unit is arranged at a rear end of the hand-held instrument.

3. A hand-held instrument according to claim 1, wherein
the transmission unit has at least two diodes that emit the infrared signals in various directions in space.

4. A hand-held instrument according to claim 3, wherein
the infrared diodes are arranged inside a cover of the housing.

5. A hand-held instrument according to claim 1, wherein
the transmission unit comprises a diode that is coupled to a light-guiding system.

6. A hand-held instrument according to claim 5, wherein
the light-guiding system is split up into a plurality of individual light-guiding fibers that emit the infrared signals in various directions in space.

7. A hand-held instrument according to claim 1, wherein
the transmission unit has comprises a diode, with a dispersion lens located in front of the diode.

8. A hand-held instrument according to claim 7, characterized in that
the dispersion lens is formed by an instrument cover.

9. A hand-held instrument according to claim 1, wherein
the transmission unit comprises a diode, with a dispersion cone or a dispersion sphere located in front of the diode.

10. A dental diagnostic system having a hand-held instrument according to claim 1 and an external display and/or evaluation unit.

11. A dental diagnostic system according to claim 10, wherein
the external display and/or evaluation unit forms a place of deposit for the hand-held instrument.

12. A dental diagnostic system according to claim 11, wherein
the external display and/or evaluation unit comprises means to identify whether the hand-held instrument has been removed from the place of deposit.

13. A dental diagnostic system according to claim 10, wherein
the external display and/or evaluation unit is adapted to be held the hand of a patient.

14. A dental diagnostic system according to claim 10, wherein
the external display and/or evaluation unit is equipped with a plurality of receivers that have various angles of view into space.

15. A dental diagnostic system according to claim 14, comprising
respective lenses arranged in front of the infrared receivers.

16. A dental diagnostic system according to claim 15, wherein
the lenses are integrated into an injection-molded housing of the external display and/or evaluation unit.

17. A dental diagnostic system according to claim 15, wherein
the lenses are cylindrical lenses.

18. A dental diagnostic system according to claim 14,
comprising respective slotted diaphragms associated with the receivers (14) there are respective slotted diaphragms.

19. A dental diagnostic system according to claim 10, wherein
the external display and/or evaluation unit comprises means to check the quality and validity of the infrared signal that is received.

20. A dental diagnostic system according to claim 19, wherein
the quality of the infrared signal that is received is displayed graphically on the screen of the external display and/or evaluation unit.
